(19) United States
(12) Patent Application Publication
(10) Pub. No.: US 2022/0153177 A1
(43) Pub. Date: May 19, 2022

(54) SEAT VOICE AND SOUND CONTROL

(71) Applicant: Lear Corporation, Southfield, MI (US)

(72) Inventors: Nitin Jadhav, Pune (IN); Pankaj Badarayani, Pune (IN); Indrajit Singha, Pune (IN); Jochen Kohlhofer, Oberding (DE); Peter Festag, Oberding (DE)

(73) Assignee: Lear Corporation, Southfield, MI (US)

(21) Appl. No.: 17/530,674

(22) Filed: Nov. 19, 2021

(30) Foreign Application Priority Data
Nov. 19, 2020 (IN) 202041050364

(51) Int. Cl. B60N 2/879; H04R 1/10; B60N 2/885; H04R 29/00

(52) U.S. Cl. CPC B60N 2/879; H04R 1/1083; H04R 2201/02; H04R 29/004; B60N 2/885

(57) ABSTRACT

A seat assembly, and method of operation, including a lateral support beans located adjacent to a seat back and having a pair of forward extending arms extending on opposite sides of a seat occupant's head, with each of the arms including a microphone fixed in the arm, flush with a passenger facing surface of the respective arm and located between a respective ear and a mouth of an occupant's head, and a speaker mounted in the arm adjacent to a respective one of the ears of the occupant's head; wherein at least one of the microphones communicates with a controller that actuates vehicle functions based on voice commands received from the microphone, and wherein each of the microphones and the speaker corresponding to each microphone communicate with an active noise cancelation system such that ambient noise detected by each of the microphones is canceled out by the corresponding speaker.

### BACKGROUND OF THE INVENTION

This invention relates to a seat with voice and sound control, especially for use in vehicle applications.

Employing voice commands to control various apparatuses, such as drivers employing voice commands in vehicles to control various vehicle functions, are in common use. However, voice command controls individually employable for each passenger seat might also be desirable, especially when extra buttons accessible to passengers to perform passenger-type functions may be eliminated.

Additionally, while overall vehicle interior active noise control may be in common use, active noise control tailored for each passenger seat might be desirable.

### SUMMARY OF THE INVENTION

According to an aspect, the invention provides a seat assembly in a vehicle including a seat bottom, a seat back extending upward from the seat bottom, and a lateral support beans located adjacent to a top of the seat back and having a pair of forward extending arms configured to extend on opposite sides of a seat occupant's head. Each of the arms may include a microphone fixed in the arm, flush with a passenger facing surface of the respective arm and configured to be located between a respective ear and a mouth of an occupant's head, and a speaker mounted in the arm and configured to be adjacent to a respective one of the ears of the occupant's head; wherein at least one of the microphones is configured to communicate with a controller that is configured to actuate vehicle functions based on voice commands received from the at least one microphone, and wherein each of the microphones and the speaker corresponding to each microphone are configured to communicate with an active noise cancelation system such that ambient noise detected by each of the microphones is canceled out by the corresponding speaker.

According to an aspect, the invention provides a method, including controlling a pair of microphones—each mounted in and flush with a passenger facing surface of a respective forward extending arm of a lateral support beans located adjacent to a top of a seat back of a seat assembly and with the lateral arms extending on opposite sides of a seat occupant's head such that each of the microphones is located between a respective ear and a mouth of the seat occupant's head—to receive voice commands and actuate vehicle functions based on the voice commands. The method may also include controlling the pair of microphones and a corresponding pair of speakers—each of the speakers mounted in a respective one of the arms adjacent to the ears of the seat occupant's head—to detect ambient noise with the microphones and employ a noise cancelation system to cancel the ambient noise detected by each microphone with the corresponding speaker.

According to another aspect, the invention provides a private sound zone for each passenger, with the cancelation of unwanted ambient sounds. Microphones mounted in headrest lateral support beans sense ambient noises and a controller employs noise cancelling software to cancel out the ambient noise via the corresponding speakers.

According to another aspect, the invention provides for activation/deactivation and adjusting of various functions within a vehicle without the need to press any buttons or knobs, or employ a touch screen. Examples of some functions that are controllable by a vehicle passenger with a voice command may include climate control around the particular seat, music being played via the speakers in the seat assembly, navigation/mapping aids, mobile phone control, in-vehicle entertainment systems, reclining and massaging built into the passenger seat.

Various aspects of this invention will become apparent to those skilled in the art from the following detailed description of the preferred embodiments, when read in light of the accompanying drawings.

### BRIEF DESCRIPTION OF THE DRAWINGS

FIG. 1 is a schematic perspective view of a portion of a vehicle in accordance with the present invention.

FIG. 2 is a schematic, perspective view of a portion of passenger seat assemblies in a vehicle in accordance with the present invention.

FIG. 3 is a schematic perspective view of a portion of a passenger seat assembly in the vehicle in accordance with the present invention.

### DETAILED DESCRIPTION OF THE PREFERRED EMBODIMENTS

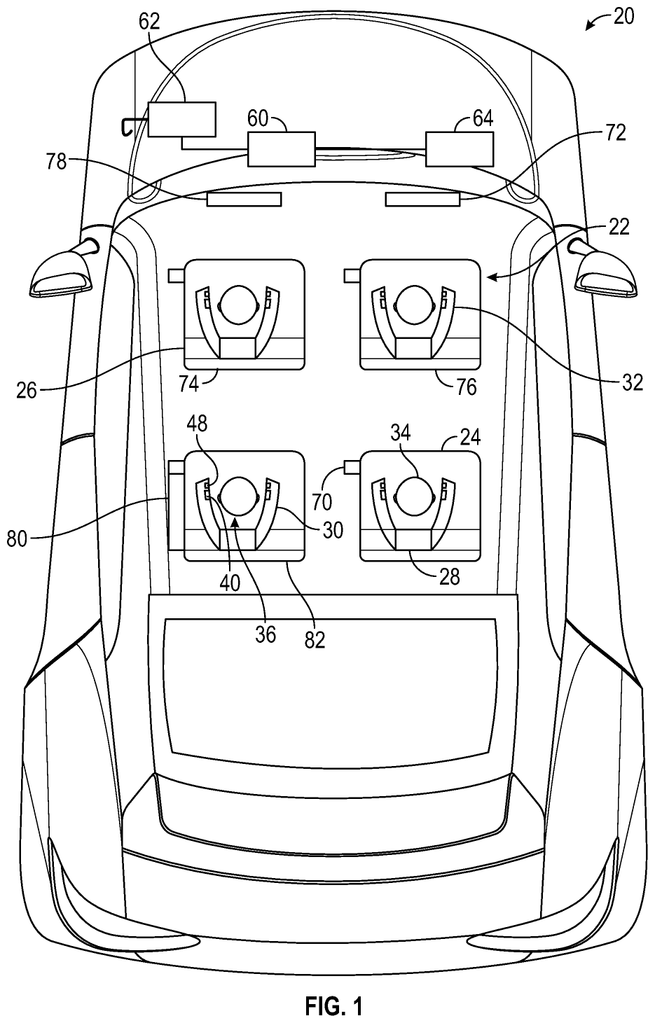

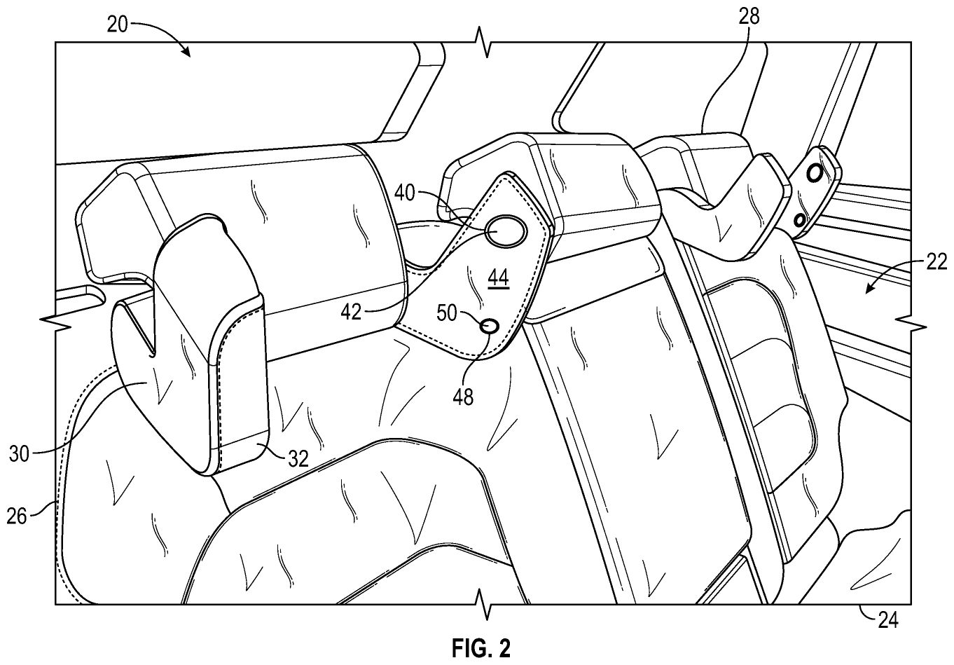

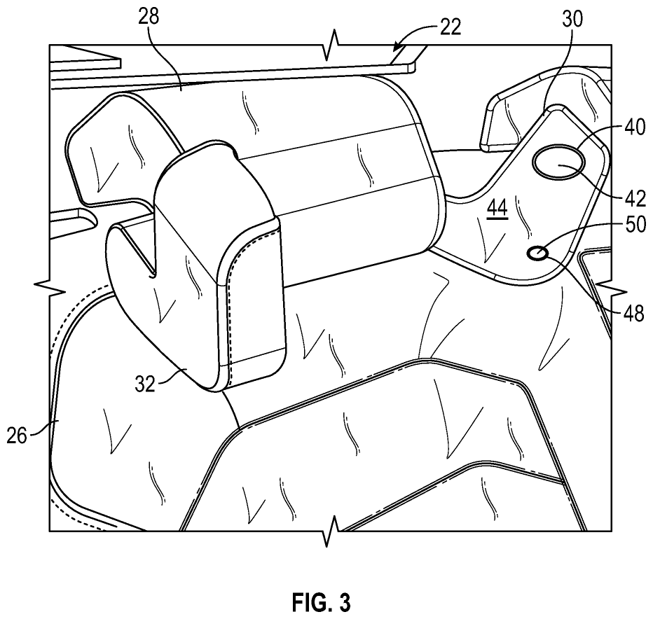

Referring now to the drawings, there is illustrated in FIGS. 1-3 a vehicle 20 having multiple passenger seat assemblies 22. As used herein, passenger seat assemblies 22 are distinguished from a driver's seat (the seat for one who is operating the vehicle)—although, in an autonomous vehicle all of the seats may be passenger seats. Each passenger seat assembly 22 may include a seat bottom 24, extending generally horizontally, a seat back 26, extending generally vertically, and a headrest 28, extending upward from the seat back 26. The headrest 28 may be movable relative to the seat back 26, for example the head rest 28 may be movable vertically and may be able to tip forward/backward in order to be adjusted for the height and sitting position of a particular passenger within that seat. The passenger seat assemblies 22 may be in any row of seats in the vehicle 20, such as a first row passenger seat(s), a second row passenger seat(s), a third row passenger seat(s) (not shown), etc.

One or more of the passenger seating assemblies 22 may include lateral support beans 30. The lateral support beans 30 may mount, for example, to a top of the corresponding seat back 26 or to the head rest 28 of the corresponding seat back 26. When mounted to the corresponding head rest 28, the lateral support beans 30 may move up/down and pivot with the corresponding head rest 28. Each of the lateral support beans 30 includes a pair of arms 32 that each extend forward from the head rest 28 (and seat back 26), with one arm 32 extending on each side of the passenger's head 34 for a passenger 36 who is occupying the particular seat. When discussing seats herein, the term forward means the direction toward the passenger occupying the seat; thus, for example, the arms 32 extending “forward” from the seat back 26 means that the arms 32 extend in a direction of the seat back that a passenger's back rests against and extend over the seat bottom upon which a passenger sits. The arms 32 may be padded to cushion an impact of the passenger's head 34 with either arm 32 due to, for example, lateral movements of the vehicle 20 and/or to act as a neck/side-headrest for the passenger 36.

Each arm 32 of each of the lateral support beans 30 may include a speaker 40. The speakers 40 are mounted within the arms 32, and a front face 42 of each speaker 40 may be essentially flush (or slightly recessed) with a passenger facing surface 44 of its corresponding arm 32. Each speaker 40 is located in its corresponding arm 32 at a position where the speaker 40 is adjacent to an ear of the passenger's head 34 for the passenger 36 occupying that seat. When the lateral support beans 30 is movable with the corresponding head rest 28, the arms 32 may be adjusted, for example by up/down and/or pivoting movement, to assure that the speakers 40 align relatively close to the ears of the passenger's head 34.

Each arm 32 of each of the lateral support beans 30 may include a microphone 48. The microphones 48 are mounted within the arms 32, and a front face 50 of each microphone 48 may be essentially flush (or slightly recessed) with the passenger facing surface 44 of its corresponding arm 32. Each microphone 48 is located in its corresponding arm 32 at a position where the microphone 48 is adjacent to a side of a face of the passenger's head 34, between the passenger's mouth and corresponding ear. When the lateral support beans 30 is movable with the corresponding head rest 28, the arms 32 may be adjusted, for example by up/down and/or pivoting movement, to assure that the microphones 48 align relatively close to the side of the passenger's head 34, between the passenger's mouth and corresponding ear.

The speakers 40 and microphones 48 may, via wired or wireless communication, be controlled by a controller 60 in the vehicle 20. The controller 60 may be a separate controller or may be integrated into other vehicle controllers, which control various functions of the vehicle. The controller 60 may be made up of various combinations of hardware and software as are known to those skilled in the art. A source of electric power 62 may provide the power needed to operate the speakers 40 and microphone 48.

The controller 60 may incorporate or communicate with an active noise cancelation system 64. The algorithms employed for active noise cancelation using microphones and speakers are known to those skilled in the art. The active noise cancelation system 64 may communicate/control the speakers 40 and corresponding microphones 48 for each passenger seat assembly 22 to create a private sound zone for the passenger 36 in each of the passenger seat assemblies 22. That is, for a particular passenger seat assembly 22, each microphone 48 will detect ambient sounds, which are fed to the active noise cancelation system 64. The active noise cancelation system 64 then determines the ambient noise canceling waves for each microphone 48 and actuates the corresponding speaker 40 in order to cancel the unwanted ambient sounds—the microphone 48 on the left side of the passenger's head 34 will be used to actuate the speaker 40 on the left side of the passenger's head 34 and the microphone 48 on the right side of the passengers' head 34 will be used to actuate the speaker 40 on the right side of the passenger's head 34.

With the microphones 48 being relatively close to the ears on each side of the passenger's head 34, the ambient noise measurement to cancel the unwanted noise at the passenger's ears will be relatively accurate. Additionally, with the speakers 40 being relatively close to the ears on each side of the passenger's head 34, the active noise cancelation may be tailored to cancel only the desired noises for that particular passenger in that seat assembly 22, without interfering with the noise cancelation for the passengers 36 in the other passenger seat assemblies 22, creating a private sound cancelation zone for each passenger seat assembly 22.

The microphones 48 and speakers 40 mounted in the lateral support beans 30 may also be used for personalized voice control of various functions relating to the passenger seat assemblies 22. Since the microphones 48 are mounted on either side of the passenger's head 34 between the passenger's mouth and ears, one or both of the microphones may be employed for voice command control. The passenger 36 in the particular passenger seat assembly 22 may speak a voice command into one of the microphones 48, with the command being received by the controller 60. The controller 60 may continuously monitor for voice commands or, optionally, there may be a voice command button 70 mounted adjacent to or in each passenger seat assembly 22 (for example in a hand rest), in which case the controller 60 only monitors for voice commands for that particular seat assembly 22 immediately after the voice command button 70 is actuated. The microphones 48 for each of the passenger seat assemblies 22 is monitored for voice commands that will be carried out for the corresponding seat, individually—creating a personal voice control for each passenger seat assembly. Since the algorithms for voice command controls are known to those skilled in the art, the details of the voice command algorithms will not be discussed herein.

The voice control may be used to perform various functions relating to passenger seat assemblies 22. For example, when the vehicle 20 has climate control (heating, ventilation, air conditioning system) 72 that may be personalized for different passenger seat assemblies 22 (e.g., different temperature settings for different passenger seats), a passenger 36 may speak into one of the microphones 48 adjacent to the passenger's head 34 to, for example, increase/decrease temperature around that particular passenger seat assembly 22, turn on/off air conditioning or heating around that particular passenger seat assembly 22 or to control other typical climate control functions.

Another example of voice control includes a passenger 36 speaking into one of the microphones 48 adjacent to the passenger's head 34 to select music or watch a video from an entertainment system 74, with the music and/or audio portion of a video to be played through the corresponding speakers 40 in that passenger seat's lateral support beans 30. With these speakers 40 being very close to that particular passenger's ears, the volume of the speakers 40 may be kept low for music listening/movie watching for the passenger 36 in that particular passenger seat assembly 22 only, with passengers 36 in other seats listening to different music/watching a different movie, or none at all. Voice control may also be employed to select particular songs, particular videos, increase/decrease volume or adjust other typical functions related to entertainment systems 74.

A further example of voice control includes a passenger 36 speaking into one of the microphones 48 adjacent to the passenger's head 34 to make a phone call via a mobile phone system 78, which may be part of a built-in vehicle communication system or may be paired with the passenger's mobile phone communicating wirelessly via the mobile phone system 78. One of the microphones 48 and one or more of the speakers 40 adjacent to the passenger's head 34 may be employed to carry on the conversation via the mobile phone system 78. The volume of the speakers 40 may be kept low since the speakers 40 are very close to that particular passenger's ears. As for the voice of the passenger 36 on the phone call, other passengers 36 may utilize the active noise cancellation 64 in their own passenger seat assemblies 22 to avoid hearing the phone conversation taking place. Voice control may also be employed to answer calls, adjust the volume of a ring tone, volume of the voices in the call or adjust other typical functions related to mobile phone systems 78.

Another example of voice control includes a passenger 36 speaking into one of the microphones 48 adjacent to the passenger's head 34 to control a navigation/mapping system 76. Voice control may be employed to bring up a certain map or route guidance on a navigation display in front of that passenger's seat assembly 22. The navigation display and the display that may be employed to show video may be the same one for each particular passenger seat assembly 22, thus giving each passenger 36 control over an individual display via voice commands.

A still further example of voice control includes a passenger 36 speaking into one of the microphones adjacent to the passenger's head 34 to control various functions for that particular passenger seat assembly 22. Voice control may be employed to control a power seat recline system 80, to activate/deactivate a built-in seat massager 82 or other typical seat control functions related to passenger seat assemblies 22

The principle and mode of operation of this invention have been explained and illustrated in its preferred embodiment. However, it must be understood that this invention may be practiced otherwise than as specifically explained and illustrated without departing from its spirit or scope.

What is claimed is:

1. A seat assembly in a vehicle comprising:
a seat bottom;
a seat back extending upward from the seat bottom;
a lateral support beans located adjacent to a top of the seat back and having a pair of forward extending arms configured to extend on opposite sides of a seat occupant's head; each of the arms including:
a microphone fixed in the arm, flush with a passenger facing surface of the respective arm and configured to be located between a respective ear and a mouth of an occupant's head, and
a speaker mounted in the arm and configured to be adjacent to a respective one of the ears of the occupant's head;
wherein at least one of the microphones is configured to communicate with a controller that is configured to actuate vehicle functions based on voice commands received from the at least one microphone; and
wherein each of the microphones and the speaker corresponding to each microphone are configured to communicate with an active noise cancelation system such that ambient noise detected by each of the microphones is canceled out by the corresponding speaker.

2. The seat assembly of claim 1, wherein the seat assembly includes a head rest mounted on top of the seat back, and the lateral support beans are mounted to the head rest.

3. The seat assembly of claim 2, wherein the head rest and the lateral support beans are configured to move relative to the seat back.

4. The seat assembly of claim 1, wherein the seat assembly includes a voice command switch that is configured to communicate with the controller to activate a voice command algorithm when actuated.

5. The seat assembly of claim 1, wherein at least one of the microphones is configured to communicate with the controller, which is configured to adjust a climate control system personalized for the seat assembly based on the voice commands.

6. The seat assembly of claim 1, wherein at least one of the microphones is configured to communicate with the controller, which is configured to actuate an entertainment system specifically for the seat assembly and send audio to the speakers in the lateral support beans based on the voice commands.

7. The seat assembly of claim 1, wherein at least one of the microphones is configured to communicate with the controller, which is configured to activate a mobile phone call and send and receive audio through the microphones and the speakers in the lateral support beans based on the voice commands.

8. The seat assembly of claim 1, wherein at least one of the microphones is configured to communicate with the controller, which is configured to actuate a navigation system personalized for the seat assembly based on the voice commands.

9. The seat assembly of claim 1, wherein the seat assembly includes a power recline system, and wherein at least one of the microphones is configured to communicate with the controller, which is configured to recline the seat assembly based on the voice commands.

10. The seat assembly of claim 1, wherein the seat assembly is a passenger seat assembly.

11. A method, comprising:
controlling a pair of microphones, each mounted in and flush with a passenger facing surface of a respective forward extending arm of a lateral support beans located adjacent to a top of a seat back of a seat assembly and with the lateral arms extending on opposite sides of a seat occupant's head such that each of the microphones is located between a respective ear and a mouth of the seat occupant's head, to receive voice commands and actuate vehicle functions based on the voice commands; and
controlling the pair of microphones and a corresponding pair of speakers, each of the speakers mounted in a respective one of the arms adjacent to the ears of the seat occupant's head, to detect ambient noise with the microphones and employ a noise cancelation system to cancel the ambient noise detected by each microphone with the corresponding speaker.

12. The method of claim 11 further comprising, moving the lateral support beans, which are mounted to a head rest above the seat back, to adjust the position of the speakers and microphones relative to the seat occupant's head.

13. The method of claim 11 further comprising, actuating a voice command switch associated with the seat assembly immediately prior to actuating the vehicle functions based the voice commands received by the microphones.

14. The method of claim 11 further comprising, adjusting a climate control system personalized for the seat assembly based on the voice commands.

15. The method of claim 11 further comprising, actuating an entertainment system for the seat assembly, sending audio to the speakers, based on the voice commands.

16. The method of claim 11 further comprising, activating a mobile phone call, sending and receiving audio through the microphones and the speakers based on the voice commands.

17. The method of claim 11 further comprising, actuating a navigation system personalized for the seat assembly based on the voice commands.

18. The method of claim 11 further comprising, actuating a power seat reclining system in the seat assembly based on the voice commands.

19. The method of claim 11 further comprising, activating a power massager in the seat assembly based on voice commands.
